(19) United States
(12) Patent Application Publication
(10) Pub. No.: US 2001/0052349 A1
(43) Pub. Date: Dec. 20, 2001

(54) Dental floss holder

(76) Inventor: Kruno S. Thaleck, Rosenheim (DE)

Correspondence Address: Kevin S. Lemack, Nields, Lemack & Dingman, 176 E. Main Street, Suite 8, Westboro, MA, 01581, US

(21) Appl. No.: 09/492,522

(22) Filed: Jan. 27, 2000

(30) Foreign Application Priority Data
Feb. 3, 1999 (DE) 199 04 381.7

(51) Int. Cl. A61C 15/00

(52) U.S. Cl. 132/323

(57) ABSTRACT

A dental floss holder has a gripping part (2) and a curved part (6) sifting on the latter, which is provided on its one end with an attachment element (10) for a piece of dental floss (8) to be tensed over the curved part. A deflecting element (4) is provided in the region of the other end of curved part (6), by means of which dental floss (8) is inverted by a finger that tenses it of the hand grasping gripping part (2). The reversing element can be configured as the transition region between gripping part (2) shaped like a knob part (4) and the throughput opening (14) for dental floss (8) which passes through curved part (6). A detachable connection, for example, in the form of a bayonet pin-and-socket (20), between curved part (6) and gripping part (2) permits a disassembly of the dental floss holder into a small size for travel as well as use of the gripping part with other attachable devices, for example, a toothbrush.

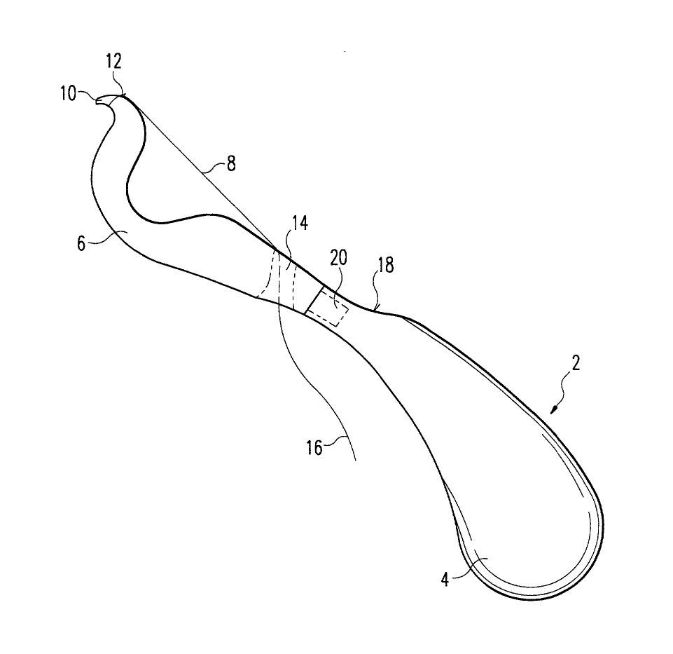

### DESCRIPTION

The invention concerns a dental floss holder with the features given in the preamble of claim 1.

Frequently food residues enter into gaps between teeth, and one attempts to remove them with a toothpick, which can be handled comfortably, but does not always produce the desired result. Basically, the spaces between the teeth can be cleaned with a piece of dental floss, which requires, however, some skill in manipulation. Therefore, a dental floss holder has been developed, in which the dental floss is tensed over a curve-shaped part, which is provided with a handle, so that one can introduce the curved part with the “dental floss cord” at the desired place in the mouth, in order to introduce the dental floss between the teeth and to move it back and forth. A disadvantage of this known dental floss holder consists of the fact that not only is the clamping and fastening of the dental floss in the curved part rather difficult and arduous, but that also the tensing of the dental floss often very rapidly slackens and thus the desired cleaning effect is no longer achieved.

The object of the invention is to create a dental floss holder, in which the tension of the dental floss can be easily regulated during utilization, so that the necessary and desired degree of tension of the floss can be produced each time when cleaning the spaces between the teeth.

This object is solved by the features indicated in claim 1. Further developments of the invention are characterized in the subclaims.

According to the invention, the dental floss is attached only to one end of the curved part, for example, suspended in a hook by a small loop, and on the opposite side of the curved part is guided over a deflecting element to the index finger of the user holding the device in hand and is wound around the finger, so that by flexing the finger, as in shooting a revolver, the dental floss running like a cord over the curved part is tensed. In this way, one can tense it more or less as desired during manipulation.

In a preferred form of embodiment of the invention, the dental floss holder is configured such that the curved part is transformed at one end into a gripping part, which is preferably shaped such that it lies easily in the hand, for example, in the form of a knob with its thick part downward, approximately in the shape of a revolver grip. The comfortable handling is also provided by a configuration of the transition region between the curved part and the gripping part as a preferably trough-shaped thumb support surface, so that a better feel is achieved for the precise determination of the dental floss tension with the curved index finger. The knob-type grip then continues over the transition region with the thumb support surface to extend in the same direction into the curved part, and in this way, a stable and long-life construction of the device can be achieved.

In a preferred form of embodiment, the deflecting element is shaped as a throughput opening for the dental floss in the transition region between knob and curved part, whereby the dental floss tensed upward over the curved part is guided through this opening into the region of the finger of the hand holding the device, where it can easily be wound around the flexed index finger. The tensing of the dental floss only requires the formation of a small loop at one end, with which it is suspended at the free end of the curved part. The other end of the dental floss need only be shifted through the opening and wound around the finger, without the necessity of a second knot or a troublesome tensing of the dental floss.

A particular form of embodiment of the invention consists of joining the gripping part and the curved part together in a detachable manner, in order to be able to utilize the gripping part also for other purposes, for example, for placement of a tooth brush, a tooth mirror, etc. An appropriate type of connection is a bayonet pin-and-socket, which is easy to manipulate and produces a secure locking of the two parts. However, plug or screw connections are also possible.

The invention will now be explained on the basis of an example of embodiment of a dental floss holder illustrated in the accompanying drawing.

A curved part 6, over which a piece of dental floss 8 can be tensed, sits on a gripping part 2, which has approximately the shape of a pistol or revolver grip with a back-end knob part 4, which tapers toward the front. For this purpose, curved part 6 bears on its free end a small hook 10, on which dental floss 8 is suspended by a small loop 12. Dental floss 8 passes like a cord over curved part 6 and is guided through a throughput opening 14 to the underside of the holder. One can easily imagine that the free end 16 of the dental floss can be wound around the index finger over one hand, which holds gripping part 2. The part of dental floss 8 running like a cord in curved part 6 is tensed to a greater or lesser extent by the flexing of this finger to a greater or lesser extent.

The transition region between gripping part 2 and curved part 6 is configured as a flattened, preferably trough-shaped thumb support surface 18, on or in which rests the thumb of the hand, the other fingers of which surround gripping part 2, whereby knob part 4 lies in the hand surface in an anatomically adapted manner.

A detachable connection between curved part 6 and gripping part 2 in the form of a bayonet pin-and-socket 20 is also indicated in the drawing, which makes possible a rapid assembly and disassembly of these two parts by plugging in and rotating these two parts. In the disassembled state, the dental floss holder only requires a very small space and can be accommodated without anything further in a toiletry kit, whereas it represents a comfortably manipulatable device in the assembled state. The detachability of curved part 6 from gripping part 2 also permits the use of the gripping part with other front parts, for example, a toothbrush, which lies very comfortably in the hand and can be introduced into the mouth easily, just like the curved part holding the dental floss.

1. Dental floss holder with a gripping part (2) and a curved part (6), seated on the latter, which is provided on one end with a fastening element (10) for securing a piece of dental floss (8) over the curved part, is hereby characterized in that a deflecting element (14) is provided in the region of the other end of the curved part (6), by means of which the dental floss (8) is inverted to a finger tensing it of the hand holding gripping part (2).

2. Dental floss holder according to claim 1, further characterized in that curved part (6) is transformed on one end into gripping part (2).

3. Dental floss holder according to claim 2, further characterized in that gripping part (2) is formed with a knob part (4), which is tapered toward curved part (6) and is transformed into the latter.

4. Dental floss holder according to claim 3, further characterized in that the deflecting element is formed as a throughput opening (14) for dental floss (8), which passes through the transition region between knob part (4) and curved part (6).

5. Dental floss holder according to claim 3, further characterized in that a preferably trough-shaped thumb support surface (1 8) is formed in the transition region between knob part (4) and curved part (6).

6. Dental floss holder according to claims 4 and 5, further characterized in that said throughput opening (14) is provided between the thumb support surface (18) and curved part (6).

7. Dental floss holder according to one of the preceding claims, further characterized in that gripping part (2) is connected in a detachable manner with curved part (6).

8. Dental floss holder according to claim 7, further characterized in that the detachable connection is formed as a bayonet pin-and-socket (20).

9. Dental floss holder according to claim 7 or 8, further characterized in that detachable connection (20) is provided between thumb support surface (18) and throughput opening (14).
